(19) United States
(12) Patent Application Publication
(10) Pub. No.: US 2024/0206437 A1
(43) Pub. Date: Jun. 27, 2024

(54) AQUARIUM MAZE INSERT ASSEMBLY

(71) Applicant: Brent Pesola, Dallas, TX (US)

(72) Inventor: Brent Pesola, Dallas, TX (US)

(21) Appl. No.: 18/088,120

(22) Filed: Dec. 23, 2022

(51) Int. Cl. A01K 63/00; A01K 63/04; A01K 63/06; F21S 4/28

(52) U.S. Cl. CPC A01K 63/006; A01K 63/045; A01K 63/06; F21S 4/28; F21Y 2115/10

(57) ABSTRACT

An aquarium maze insert assembly for integrating a maze within the tank includes a tank being an aquarium. The tank has a plurality of walls. Each of the walls has a top edge and a bottom edge. The bottom edge of each of the walls is positioned on a base. A space between each of the walls and the base defines an interior. In addition to the interior, the top edge of each of the walls defines an opening to the interior. A maze is positioned within the interior of the tank. The maze includes a plurality of inserts where each of the inserts creates a maze path. A lid is positioned upon the opening of the tank. The lid has a top surface and a bottom surface with a filter attached to the bottom surface of the lid. A battery housing is positioned upon a top surface of the lid.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to aquarium device and more particularly pertains to a new aquarium device for integrating a maze within the tank.

### (2) Description of Related Art Including Information Disclosed Under 37 CFR 1.97 and 1.98

The prior art relates to aquarium devices. The prior art relates to a variety of aquarium devices configured for holding a variety of fish. Furthermore, the prior art includes a variety of aquarium devices having a path for fish to follow. Known prior art lacks an aquarium device configured for inserting a maze within the interior of the tank.

### BRIEF SUMMARY OF THE INVENTION

An embodiment of the disclosure meets the needs presented above by generally comprising a tank configured for being an aquarium. The tank has a plurality of walls, and each of the walls has a top edge and a bottom edge. The bottom edge of each of the walls is positioned upon a base. A space between each of the walls and the base defines an interior. Furthermore, the top edge of each of the walls defines an opening. A maze is positioned within the interior of the tank. The maze comprises a plurality of inserts. Additionally, the plurality of inserts is configured for creating a maze path. A lid is positioned upon the opening of the tank. The lid has a top surface and a bottom surface. A filter is coupled to the bottom surface of the lid, and a battery housing is positioned upon a top surface of the lid.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a aquarium maze insert assembly according to an embodiment of the disclosure.

FIG. 2 is a top isometric view of an embodiment of the disclosure.

FIG. 3 is a side view of an embodiment of the disclosure.

FIG. 4 is a top view of an embodiment of the disclosure.

FIG. 5 is an in-use view of an embodiment of the disclosure.

FIG. 6 is a detail view of an embodiment of the disclosure.

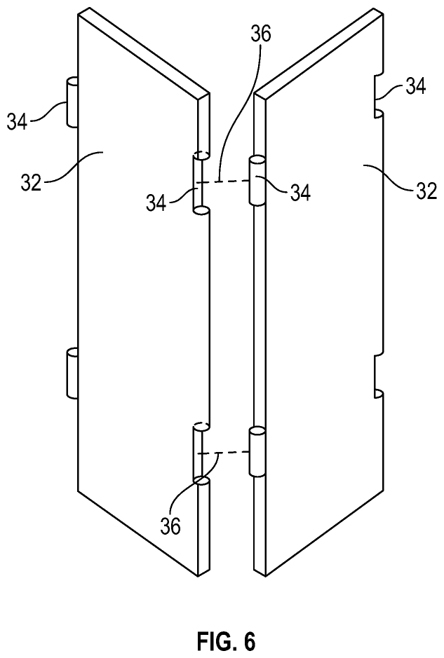

### DETAILED DESCRIPTION OF THE INVENTION

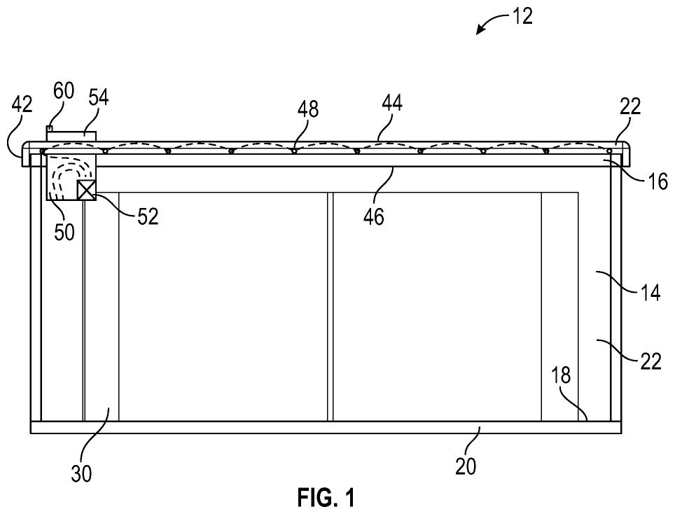

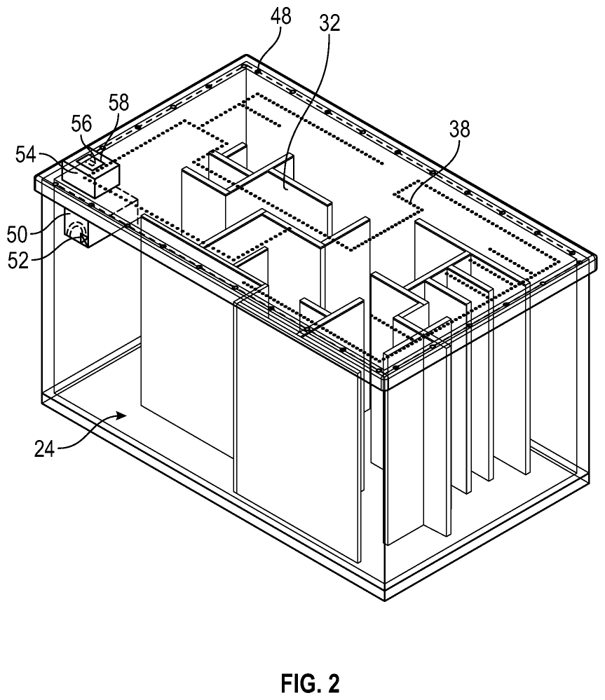

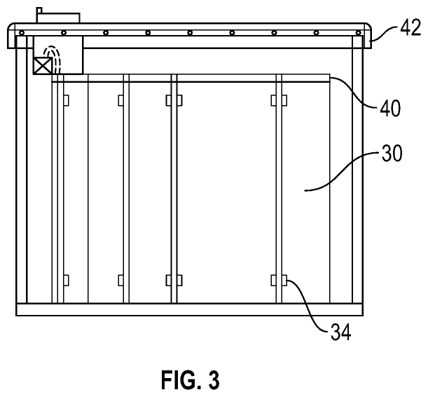

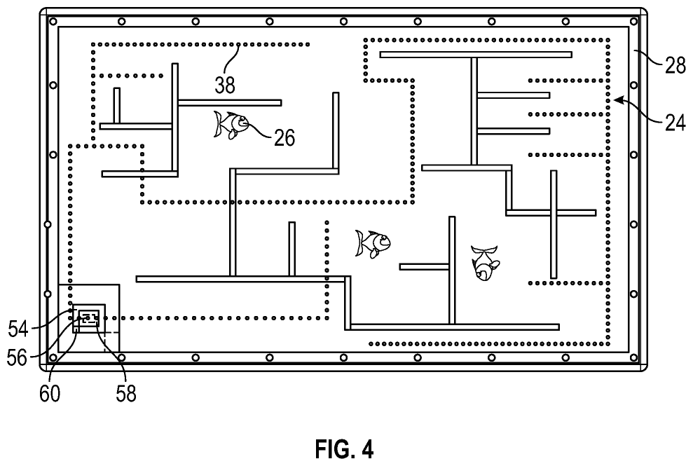

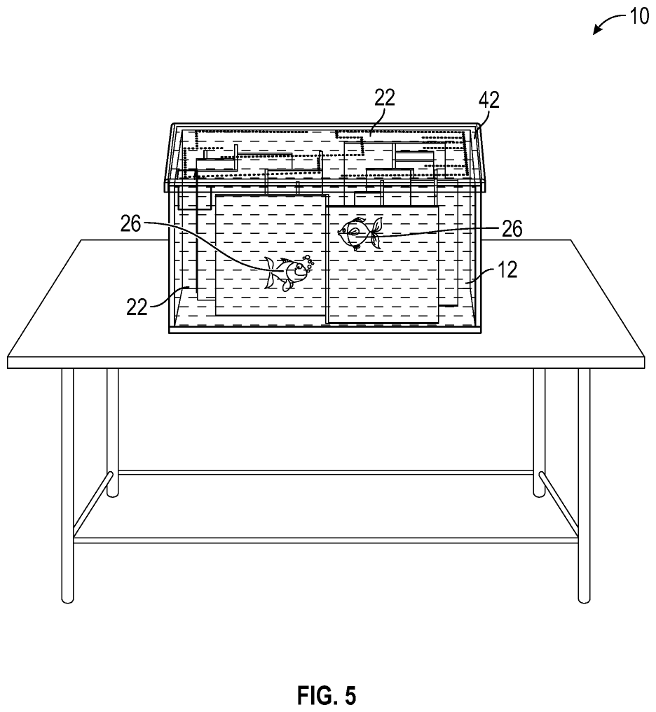

With reference now to the drawings, and in particular to FIGS. 1 through 5 thereof, a new aquarium device embodying the principles and concepts of an embodiment of the disclosure and generally designated by the reference numeral 10 will be described.

As best illustrated in FIGS. 1 through 5, the aquarium maze insert assembly 10 generally comprises a tank 12. The tank 12 is configured for being an aquarium. The tank 12 has a plurality of walls 14. Each of the walls 14 has a top edge 16 and a bottom edge 18. The bottom edge 18 of each of the walls 14 is positioned upon a base 20. The base 20 is configured supporting the tank 12 against a surface, such as a table. Each of the walls 14 is a transparent material 22. The transparent material 22 is configured for emitting light particles through each of the walls 14, wherein each of the walls 14 is able to see through. The transparent material 22 allows the user to see within the tank 12 from the outside. A space between each of the walls 14 and the base 20 defines an interior 24. The interior 24 is configured for holding water and a variety of aquatic creatures 26, such as fish. The top edge 16 of each of the walls 14 defines an opening 28. The opening 28 is an aperture configured for accessing the interior 24 of the tank 12 from the outside.

A maze 30 is positioned within the interior 24 of the tank 12. The maze 30 comprises a plurality of inserts 32. Each of the inserts 32 has a pair of clasps 34 of a snap clasp fastener 36, wherein each of the inserts 32 is configured for coupling to each other by the snap clasp fastener 36. The plurality of inserts 32 is configured for creating a maze path 38. The maze path 38 is a plurality of trails from a start point to an end point. Each of the inserts 32 couples to each other to create the maze path 38. Furthermore, each of the inserts 32 has a top end 40, wherein the top end 40 of each of the inserts 32 is configured for being colorable. The colorable top end 40 would help depict the maze path 38 when viewing the interior 24 of the tank 12 from the opening 28 of the tank 12.

A lid 42 is positioned upon the opening 28 of the tank 12. Additionally, the lid 42 is removable from the tank 12. The lid 42 is configured for enclosing the interior 24 of the tank 12. The lid 42 is the transparent material 22, similar to each of the walls 14. The lid 42 has a top surface 44 and a bottom surface 46. A plurality of lights 48 is positioned between the top surface 44 and the bottom surface 46 of the lid 42. Each of the lights 48 is a light emitting diode being configured for illuminating the interior 24 of the tank 12 when the lid 42 is positioned upon the tank 12.

A filter 50 is coupled to the bottom surface 46 of the lid 42. The filter 50 is configured for removing debris from the water of the interior 24 of the tank 12, wherein the filter 50 purifies the water. The filter 50 helps clean the water and provide clarity to the water as well. The filter 50 has a pump 52 being configured for flowing the water through the filter 50. Furthermore, a battery housing 54 is positioned upon a top surface 44 of the lid 42. The battery housing 54 is configured for holding a pair of disposable batteries 56. The pair of disposable batteries 56 is positioned within a compartment 58 of the battery housing 54. The battery housing 54 has a switch 60 being an actuator for providing or stopping electric flow from the pair of disposable batteries 56 to the plurality of lights 48 of the lid 42 and the pump 52 of the filter 50.

In use, the user assembles a maze path 38 from the plurality of inserts 32. Subsequently, the user removes the lid 42 from the tank 12 to insert the maze 30 within the interior 24 of the tank 12. The maze 30 rests upon the base 20 of the tank 12 when inserted within the water of the interior 24. The user places the lid 42 back onto the opening 28 of the tank 12. The user can observe the aquatic creatures 26 use the maze 30 through the plurality of walls 14 and through the lid 42 as well. The plurality of inserts 32 may be preassembled with the maze path 38 within the interior 24 of the tank 12 and the user may disassemble the maze 30 to customize the maze path 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An aquarium maze insert assembly configured for producing a maze path within a fish tank, the aquarium maze insert assembly comprising:
A tank configured for being an aquarium, said tank having a plurality of walls, each of said walls having a top edge and a bottom edge, said bottom edge of each of said walls being positioned upon a base, a space between each of said walls and said base defining an interior, said top edge of each of said walls defining an opening;
a maze being positioned within said interior of said tank, said maze comprising a plurality of inserts, said plurality of inserts being configured for creating a maze path;
a lid being positioned upon said opening of said tank, said lid having a top surface and a bottom surface;
a filter being coupled to said bottom surface of said lid; and
a battery housing being positioned upon a top surface of said lid.

2. The aquarium maze insert assembly of claim 1, further comprising said base being configured supporting said tank against a surface,

3. The aquarium maze insert assembly of claim 1, further comprising each of said walls being a transparent material, said transparent material being configured for emitting light particles through each of said walls wherein each of said walls being see through.

5. The aquarium maze insert assembly of claim 1, further comprising said interior being configured for holding water and a variety of aquatic creatures.

6. The aquarium maze insert assembly of claim 1, further comprising said opening being an aperture configured for accessing said interior of said tank from the outside.

7. The aquarium maze insert assembly of claim 1, further comprising each of said inserts having a pair of clasps of a snap clasp fastener, each of said inserts being configured for coupling to each other by said snap clasp fastener.

8. The aquarium maze insert assembly of claim 1, further comprising said maze path being a plurality of trails from a start point to an end point within a structure.

9. The aquarium maze insert assembly of claim 1, further comprising each of said inserts having a top end, said top end of each of said inserts being configured for being colorable.

10. The aquarium maze insert assembly of claim 1, further comprising said lid being removable from said tank, said lid being configured for enclosing said interior of said tank.

11. The aquarium maze insert assembly of claim 1, further comprising said lid being said transparent material.

12. The aquarium maze insert assembly of claim 1, further comprising a plurality of lights being positioned between said top surface and said bottom surface of said lid, each of said lights being a light emitting diode, each of said lights being configured to illuminating said interior of said tank when said lid being positioned upon said tank.

13. The aquarium maze insert assembly of claim 1, further comprising said filter being configured for removing debris from the water of said interior of said tank, said filter having a pump, said pump being configured for flowing the water through said filter.

14. The aquarium maze insert assembly of claim 1, further comprising said battery housing configured for holding a pair of disposable batteries, said pair of disposable batteries being positioned within a compartment of said battery housing, said battery housing having a switch, said switch being an actuator for providing or stopping electric flow from said pair of disposable batteries to said plurality of lights of said lid and said pump of said filter.

15. An aquarium maze insert assembly configured for producing a maze path within a fish tank, the aquarium maze insert assembly comprising:
a tank configured for being an aquarium, said tank having a plurality of walls, each of said walls having a top edge and a bottom edge, said bottom edge of each of said walls being positioned upon a base, said base being configured supporting said tank against a surface, each of said walls being a transparent material, said transparent material being configured for emitting light particles through each of said walls wherein each of said walls being see through, a space between each of said walls and said base defining an interior, said interior being configured for holding water and a variety of aquatic creatures, said top edge of each of said walls defining an opening, said opening being an aperture configured for accessing said interior of said tank from the outside;
a maze being positioned within said interior of said tank, said maze comprising a plurality of inserts, each of said inserts having a pair of clasps of a snap clasp fastener, each of said inserts being configured for coupling to each other by said snap clasp fastener, said plurality of inserts being configured for creating a maze path, said maze path being a plurality of trails from a start point to an end point within a structure, each of said inserts having a top end, said top end of each of said inserts being configured for being colorable;
a lid being positioned upon said opening of said tank, said lid being removable from said tank, said lid being configured for enclosing said interior of said tank, said lid being said transparent material, said lid having a top surface and a bottom surface, a plurality of lights being positioned between said top surface and said bottom surface of said lid, each of said lights being a light emitting diode, each of said lights being configured to illuminating said interior of said tank when said lid being positioned upon said tank;
a filter being coupled to said bottom surface of said lid, said filter being configured for removing debris from the water of said interior of said tank, said filter having a pump, said pump being configured for flowing the water through said filter; and
a battery housing being positioned upon a top surface of said lid, said battery housing configured for holding a pair of disposable batteries, said pair of disposable batteries being positioned within a compartment of said battery housing, said battery housing having a switch, said switch being an actuator for providing or stopping electric flow from said pair of disposable batteries to said plurality of lights of said lid and said pump of said filter.
